(19) United States
(12) Patent Application Publication
(10) Pub. No.: US 2017/0021510 A1
(43) Pub. Date: Jan. 26, 2017

(54) BIDIRECTIONAL DEVICE FOR CHANGING A HANDLING GLOVE, AND METHOD FOR REPLACING SAID GLOVE

(71) Applicant: PIERCAN, Paris (FR)

(72) Inventor: Dominique GUERIN, Trevieres (FR)

(21) Appl. No.: 15/124,981

(22) PCT Filed: Mar. 10, 2015
(86) PCT No.: PCT/EP2015/054881

§ 371 Date: Sep. 9, 2016

(30) Foreign Application Priority Data
Mar. 13, 2014 (FR) 1452089

(51) Int. Cl. B25J 21/02

(52) U.S. Cl. CPC B25J 21/02

(57) ABSTRACT

A bidirectional device for changing a handling glove from inside to outside and from outside to inside a glove box under containment. The device is intended to replace a used glove (60) with a new glove. It includes a cuff (6) sealingly connected to a cuff sleeve (20) and a glove (60) of a flexible material sealingly connected to a glove sleeve (40). The glove sleeve includes externally clip-on contacts and the cuff sleeve includes bayonet type helical ramps (30). The clip-on contacts of the glove sleeve slip in the helical ramps of the cuff sleeves until the glove sleeve is latched forming, once assembled, a sealed whole called a wrist ring (10).

The present invention relates to the interchangeability of handling gloves with or without flange, under continuous sealing containment in the following industrial fields: pharmacy, animals, chemicals, etc. More precisely, the invention relates to a bidirectional device for changing a handling glove from inside to outside a glove box or from outside to inside the glove box also called: a containment envelope or insulator.

Said device is intended to replace a used glove with a new glove, including a cuff sealingly connected to a cuff sleeve and a glove of a flexible material sealingly connected to a glove sleeve. The assembly thus formed is called a wrist ring.

The invention also relates to a method for replacing a used glove with a new glove by means of the device according to the present invention.
The handling of toxic products, very volatile chemicals is commonly performed in confined media. Confined media are also used to protect the elements from outside pollution, when a handling in sterile medium is intended, for example in the case of the pharmaceutical industry for packaging injectable drugs, breeding laboratory animals under aseptic conditions, anticancer drugs handled in hospital pharmacies, agro-food industry, etc.

These confined media include a sealed envelope. To be able to make handlings from outside the envelope, this has apertures to which gloves are attached. Thus, a person introducing his/her hand in a glove, can handle objects contained in the envelope without any risk to pollute them and without risk of being contaminated.

These gloves are mounted to the envelope in several ways, for example through collars integral with the envelope, called shoulder rings for gloves attached by an envelope collar or ring for gloves mounted on an interchangeable supporting collar by an ejection mechanism, called an ejection gun, replacing the collar of the used glove by a collar of a new glove by pushing.

The shoulder rings are used both for depressurised cells and pressurised cells. The shoulder rings span the hand, the arm of the operator up to the shoulder.

The ejectable systems on collar are only used to date for depressurised cells because the ejection mechanism is large in volume and weight and it cannot be used from inside the containment.

In particular in the animal and pharmaceutical fields in sterile containment, the glove in a single length is split into two elements, that is a top part, being more resistant, called a cuff. This is connected at the envelope to a shoulder ring that can be circular or oval and with a significant size to offer more clearance to the operator. On the other hand, the glove is split into a bottom part which is connected to a sleeve at the wrist and enables a glove suitable for each handling to be mounted. This glove can be changed with a new glove from inside the envelope using the other hand. However, the changing method is very cumbersome. This method is conceivable at a research laboratory but certainly not in an industrial environment and hospital pharmacies.

From document FR 2 913 362, a method for changing a glove mounted beforehand on a glove collar accommodated in the cuff collar attached to its end is known.

The interchangeability of the used glove is achieved by conveying inside the envelope of a new sterile glove. This glove is mounted in a tooling called a “support”. From inside the cuff, a second tooling called a “pusher” is fed. The glove is engaged to the cuff collar and from the internal side of the insulator, the support containing the new glove fixed to its collar is brought to engage it to the collar of the used glove. The slipping of the cuff collar from the used glove collar up to the new glove collar is operated by pushing the pusher responsive to the support.

This method requires dexterity from the operator and remains complex.

The specific toolings, being the pusher and the support, enable for one the used glove and for the other the new glove to be received in cavities without pinching risk, hence the fact that toolings have non-negligible overall space in cell, in particular for the pusher.

The principle retained for the glove collars to afford interchangeability are of two stages. This collar consists of a first sleeve the lower diameter of which is accommodated inside the cuff collar and a second sleeve having a diameter lower than the diameter of the first sleeve enabling the glove to be mounted and attached by a collar having two diametrically opposed heads. The diameter of the heads should be lower than the inner diameter of the first sleeve in order to make it possible for the one to penetrate the other which is necessary to the interchangeability principle retained.

The major drawbacks of this principle are a decrease in the dexterity of the operator because of the thickening of the glove collar consisting of two sleeves and the increase in its length generated by their superimposition. The consequence of this state is to increase the weight and overall space of the glove at the wrist of the operator, which decreases by the same amount his/her dexterity and increases by the same amount his/her tiredness.

The axial stopping of the glove collar in the cuff collar is achieved using hard spots. In the case of the previously described sealing means, the interchangeability strain becomes continuous and thus makes the operator losing the feeling of passing the hard spots of the locking means being indicative of the end of attachment. Then, the operator is not ensured to have ended the transfer of the glove to the sleeve collar. He/she is at risk of taking out the pusher with the used glove before placing the new glove on the collar.

The secondary drawbacks of this principle are the following ones:
the placement of the first glove requires a mask or an appropriate tooling;
the frustro-conical shaped lid requires the increase in the piston stroke of the support by a value equal to the height of the lid, which results in increasing the overall space and weight of the toolings;
the orientation of the glove can be erroneous. Indeed, the glove can be placed a thumb upwards, which is the proper position or thumb downwards which is an improper position. There is no foolproofer enabling the proper upwardly thumb position to be surely ensured.

Consequently, the present invention has the purpose to provide a device for changing a glove on a sleeve overcoming the abovementioned drawbacks and offering a great safety and ease of operation for operators concerning containment.

### DISCLOSURE OF THE INVENTION

A first object of the invention is a device for changing a handling glove from inside to outside a glove box and from outside to inside under confinement, said device being intended to replace a used glove with a new glove, including a sleeve sealingly connected to a shoulder ring sealingly mounted to the wall of a containment envelope sealingly connected to a cuff sleeve, and a glove of a flexible material sealingly connected to a glove sleeve.

According to the invention, the glove sleeve includes externally a determined number of clip-on contacts located on the flexible sectors and the cuff sleeve whose inner surface is unobstructedly cylindrical, includes internally a same number of bayonet type helical ramps for guiding the clip-on contacts on the anchor cavities, latching the glove sleeve into the cuff sleeve, forming, once assembled, a sealed whole called a wrist ring.

The clip-on contacts of the glove sleeve are engaged in the helical grooves of the cuff sleeve. The contacts mounted on flexible sectors are clipped into small cavities latching the glove sleeve in the cuff sleeve, such that the sealed whole forms an undissociable wrist ring.

The glove interchangeability does not require any tooling.

The interchangeability for a new glove is made by introducing the contacts of the glove sleeve body in the peripheral inlets of the helical grooves of the cuff sleeve in a synchronised manner, cancelling tenons come to cancel the contacts of the glove sleeve to be changed, releasing them and by a rotation of about 40° clockwise by following the helical grooves of the cuff sleeve come to be clipped and latch the new glove sleeve while releasing the old one.

A static and dynamic sealing, during interchangeability, consists advantageously at least of a seal, for example having lobes and a O-ring, either injected or sealingly embedded in the throat of the glove sleeve provided on the glove sleeve body, in order to ensure a permanent sealing between the cuff sleeve and the glove sleeve.

This sealing is continuously held upon changing the glove sleeve.

The slipperiness of the seal elastomer between the cuff collar and the glove collar is improved by a surface ionisation which has the advantage to harden the elastomer only at the surface and to decrease the friction coefficient, increasing its durability and its resistance to sterilising products. Bombarding the elastomer during the surface ionisation with silver ions makes the surface active to the neutralisation of bacteria, which brings about two significant advantages: slipperiness and an antibacterial action, the combined translation/rotation movement of the glove sleeve against the inner wall of the cuff sleeve body is thus achieved without strain and enhances the integrity of the glove change by its antibacterial action.

Preferably, the device for changing the glove including a seal with lobes of elastomer has undergone a surface ionisation enabling its slipperiness properties to be improved facilitating the placement of a new collar and the ejection of the old one.

It includes clip-on contacts (49) and contact cancelling tenons (47) provided with a visual and mechanical foolproofing system, such that the glove is always put into the right working position.

The device for changing the glove does not require any specific tool to perform the interchangeability handling by the operator, visual marks are used for facilitating displaying during interchangeability actions being performed by a translation followed by a rotation of about 40°.

Preferably, the device for changing the glove includes a latching system consisting of clip-on contacts introduced into appropriate cavities. These clip-on contacts can be unclipped only when cancelling tenons are introduced into housings of the flexible sectors to cancel to inside the glove sleeve, this action resulting in unclipping these clip-on contacts.

Preferably, the device for changing the glove includes a glove sleeve consisting of a glove sleeve body including the devices for guiding and latching this glove sleeve body in the cuff sleeve body. It includes a glove assembling collar of the glove into the glove sleeve body, the holding being ensured by gluing the glove assembling collar in the glove sleeve body.

The sealing between the glove sleeve body and the glove assembling collar is ensured by pressing the elastomer of the glove and the gluing resin between both elements.

Preferably, the device for changing the glove consists of the cuff sleeve body and a cuff assembling collar. The assembling collar comes to press the sleeve against the cusp of the cuff sleeve body, thus ensuring the sealing of the cuff sleeve, the whole being held by a resin type glue making them undissociable.

Another main object of the invention is a method for replacing a used glove with a new glove by means of a device as previously described.

It comprises the following phases:
a new glove equipped with its glove sleeve is placed inside the containment envelope;
both cuff sleeve assembling and glove assembling collars are secured to each other by snapping them;
the new glove sleeve is pushed and rotated as a single piece in the used glove sleeve to the cuff sleeve until the new sleeve is latched in the helical ramps of the cuff sleeve body until the visual positioning provided is reached and a “click” for latching and full clearing of the used glove sleeve from inside the sleeve is heard.

On the slice of the used glove sleeve body, at least three female slots are provided for accommodating the three male slots for driving the new glove sleeve in the proper position, that is thumb upwards. Three housings are also provided in the flexible sectors accommodating the tenons of the new glove sleeve for unclipping the contacts of the used glove sleeve.

The interchangeability does not require any tooling in the case of a two-glove working station. It is sufficient to take the new glove sleeve with the other hand through the glove, to display it on the wrist ring along the marks provided on the cuff and glove sleeves, to engage the contacts into the helical grooves by holding the faces of the glove sleeves against each other and to push/rotate. The used glove sleeve is discharged as the translation and rotation proceed, the new glove sleeve is clipped and the used glove sleeve falls inside the cuff.

Preferably, the security at the end of the cycle rotatably stops the new glove sleeve with respect to the cuff sleeve, it is ensured by locking the contacts into cavities therefor, prohibiting any radial and axial movement. The operator is ensured of the proper latching of the glove sleeve by an auditory signal being “click” and an indicator of visual positioning. Both these signals prove that the glove is actually latched in a right position.

Advantageously, the seal of elastomer contains a decontaminant agent which neutralises possible bacteria that can come from inside the sleeve, advantageously the seal because of its configuration will provide sealing for the connection.

According to the process for replacing a used glove with a new glove by means of a device according to the invention:
in the case of the use of a depressurised system, the sleeve is then pulled out to outside the cell, whereas in the case of the use of a pressurised system, the used glove is pulled out to outside the cuff;
in the depressurised case, the new glove is pulled out to inside its sleeve;
a new glove equipped with its glove sleeve is placed inside the containment cell (Insulator) in the pressurised case and outside in the depressurised case;
in both cases, pressurised and depressurised, the new glove sleeve is displayed to the used glove sleeve in place in the cuff sleeve body making sure to align the mark of the new sleeve with the mark of the cuff sleeve body. The slops at the inlet of the housings enabling the tenons to be pre-centred;
the new glove sleeve is pushed to the old glove sleeve, which results in engaging the male slots in the female slots of the old glove sleeve and in the same movement, in engaging the cancelling tenons into the housings of the old glove sleeve. This results in cancelling the clip-on contacts to inside the previous glove sleeve;
both glove sleeves are rotated as a single piece (this is made possible by the male and female slots) by a rotation of about 40° in the cuff sleeve body, thus making latching the new glove sleeve into the cuff sleeve body, under the effect of the clip-on contacts in the helical ramps of the cuff sleeve body, up to the visual positioning of the new glove sleeve in alignment with the mark for the latching end located on the cuff sleeve body, indicated by a “click”.

The used glove sleeve is cleared off the inside the cuff in the case of the use of the pressurised system. In the case of the use of the depressurised system, the used glove sleeve is cleared off inside the glove box.

### BRIEF DESCRIPTION OF THE DRAWINGS

Further characteristics and advantages of the present invention will further appear upon reading the description that follows of one exemplary embodiment given by way of illustrating purposes making reference to the appended drawings. In these figures:

FIG. 1 is a view of a glove box including a device for changing a handling glove in accordance with the present invention;

FIG. 2 represents mounting the wrist ring for use in a pressurised glove box;

FIG. 3 represents mounting the wrist ring for use in a depressurised glove box. It is noticed for this that it is sufficient to turn back the cuff sleeve body as well as the glove sleeve whose glove mounting is made from outside to inside the glove box;

FIG. 4a shows the glove sleeve alone;

FIG. 4b shows the cuff sleeve alone;

FIG. 4c shows the assembly becoming the wrist ring consisting of the glove sleeve mounted in the cuff sleeve;

FIG. 5 represents an outside view of the assembly comprising: the cuff, the wrist ring and the glove. The thumb of the glove in high vertical position in alignment with the mark of the cuff sleeve is noticed;

FIG. 6 represents in an enlarged scale a cross-section of FIG. 5, on which the composition of the wrist ring and in particular the seal ensuring integrity between inside the cuff sleeve and outside the glove sleeve can be seen in detail;

FIG. 7 represents the cuff sleeve body making appear the inlets and helical grooves accommodating the clip-on and latching contacts;

FIG. 8 represents the cuff sleeve assembling collar, this is snapped to the cuff sleeve body, pressed and glued bearing against the cuff the whole being on the shoulder of the cuff sleeve body thus ensuring sealing and absolute holding of the cuff;

FIGS. 9 and 9a represent the glove sleeve body making appear the clip-on and latching contacts, the flexible sectors supporting the clip-on and latching contacts and the housings accommodating the cancelling tenons of these clip-on and latching contacts during interchangeability as well as the rotatable driving male and female slots;

FIG. 10 represents the glove sleeve assembling collar, this collar assembling the glove to the glove sleeve body by pressure and gluing thus ensuring sealing and absolute holding of the glove.

### DETAILED DESCRIPTION OF THE INVENTION

Marks followed by the letter “a” designate the mounted pieces for a pressurised operation. Marks followed by the letter “b” designate the mounted pieces for a depressurised operation.

The same pieces afford to make a mounting for the pressurised cells, as well as for the depressurised cells by inverting the cuff sleeve body 21a (pressurised mounting) or 21b (depressurised mounting) and the glove sleeve body 40a, 40b. In the case of the depressurised cell mounting, the glove 60b is pulled out on its assembling collar 42a or 42b.

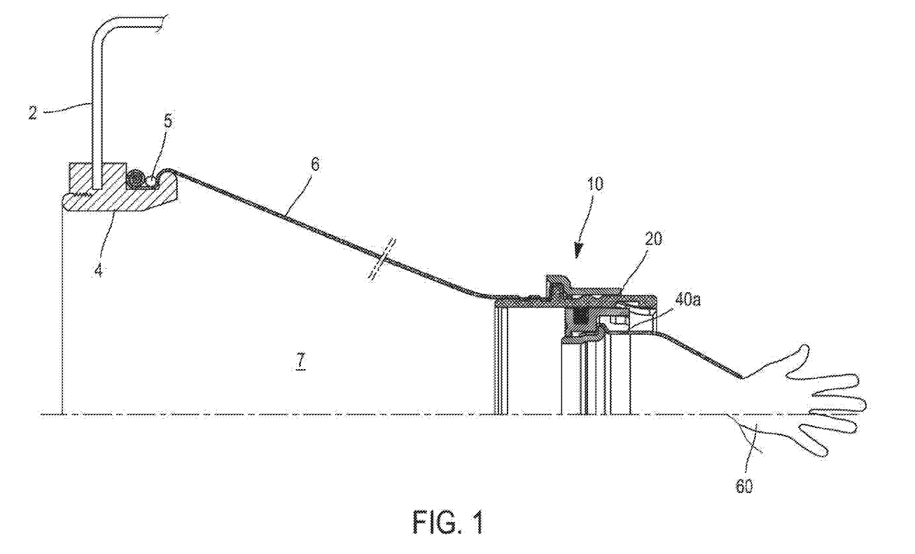

In FIG. 1, is represented a device for changing a pressurised handling glove. This device is attached to a shoulder ring 4 sealingly mounted to a wall 2 of a containment envelope in the present case, the cuff 6 being attached to the shoulder ring by a collar 5. The cuff 6 can be attached to the shoulder ring by any other appropriate method, for example by anchoring in a cavity by silicone injection, by pinching the skin of the cuff 6 by a glued intermediate piece, by gluing or by welding depending on the materials present. At its end opposite to that attached to the glove ring, the cuff 6 is attached to a cuff sleeve 20a in which a glove sleeve 40a is mounted. A glove 60a is attached to the glove sleeve 40a. The assembly formed by the cuff sleeve 20a and the glove sleeve 40a is called a wrist ring 10a.

The glove 60a is mounted to the glove sleeve 40a by any appropriate method, and in particular it can be mounted by anchoring and pinching by means of an assembling collar pressed and glued in the glove sleeve.

The internal volume of the cuff 7 corresponds to the outer atmosphere of the glove box.

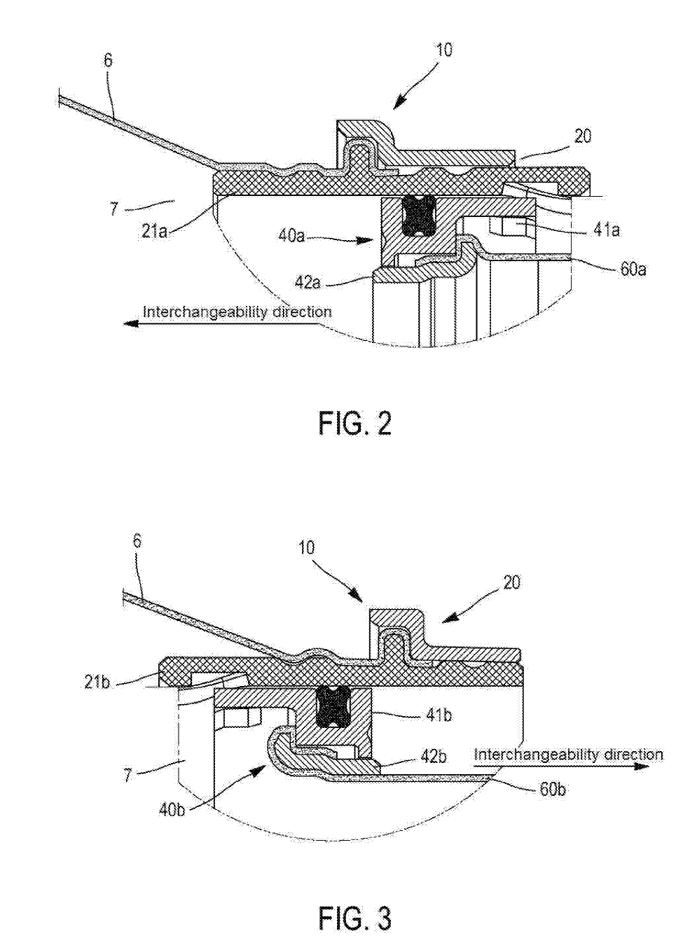

In FIG. 2, is represented the mounting of the wrist ring affording with the same pieces an interchangeability from inside to outside, corresponding to a use of a pressurised glove box, used in particular in pharmacy.

In FIG. 3, is represented the mounting of the wrist ring affording with the same pieces to perform an interchangeability without particular tool from outside to inside corresponding to a use of a depressurised glove box. The cuff sleeve body 21b is inverted, the cuff 6 is attached in a way identical to FIG. 2. The glove sleeve 40b is displayed by inside the cuff which implies to mount the glove 60b by turning it back to its assembling collar 42b.

Hereinafter, is considered the case of a pressurised cell (in this case, the marks of the pieces are followed by the letter a). The glove changing is thus made from inside to outside the envelope.

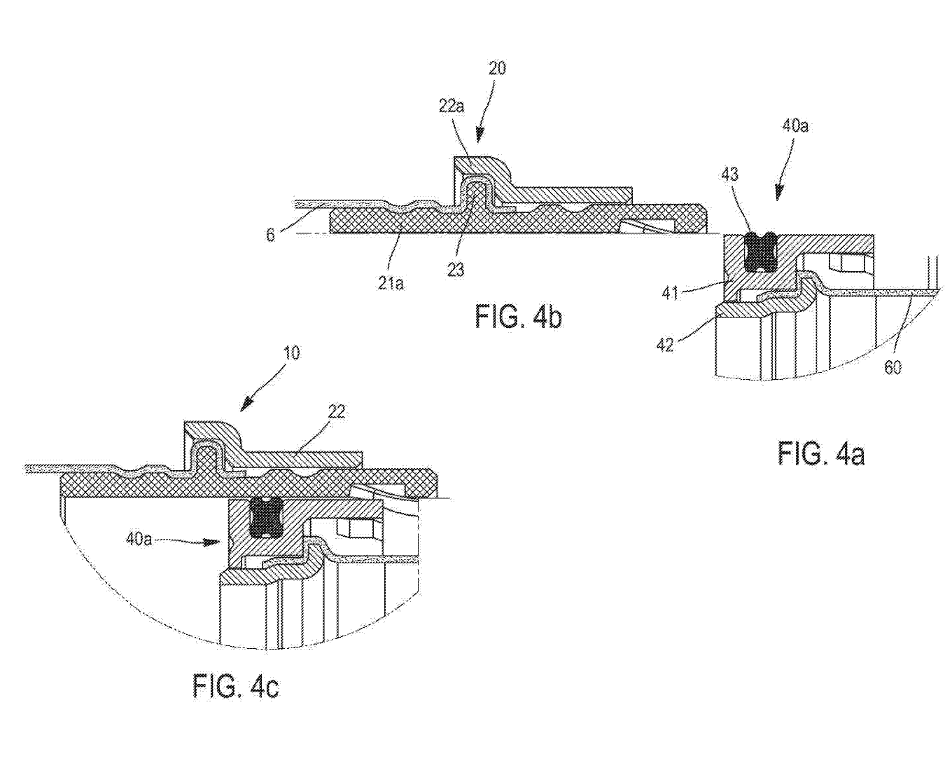

FIG. 4a represents the glove sleeve 40a consisting of a glove sleeve body 41a on which a seal 43 is mounted in a throat. A glove 60a without a flange is fitted to its glove assembling collar 42b, the assembly being inserted into the glove sleeve body 41a in a sealed manner by pressing and gluing or welding, making it undissociable from its glove assembling collar 42b thus forming the glove sleeve 40a.

FIG. 4b represents the cuff sleeve 20a consisting of a cuff sleeve body 21a on which is mounted above a cusp 23 the cuff 6, the assembling collar of the cuff sleeve 22a being inserted on the cuff sleeve 21a in a way identical to the glove assembling collar 42a.

FIG. 4c represents the glove sleeve 40a manually placed without particular tool in the cuff sleeve 20a thus forming the wrist ring 10a.

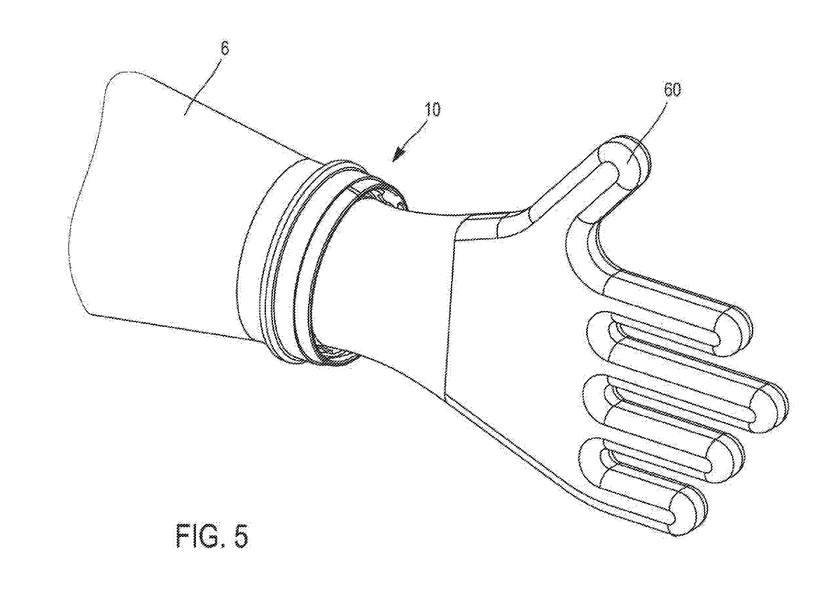

FIG. 5 shows the wrist ring cuff 10a and glove 60a assembly properly mounted, thumb vertically directed upwards.

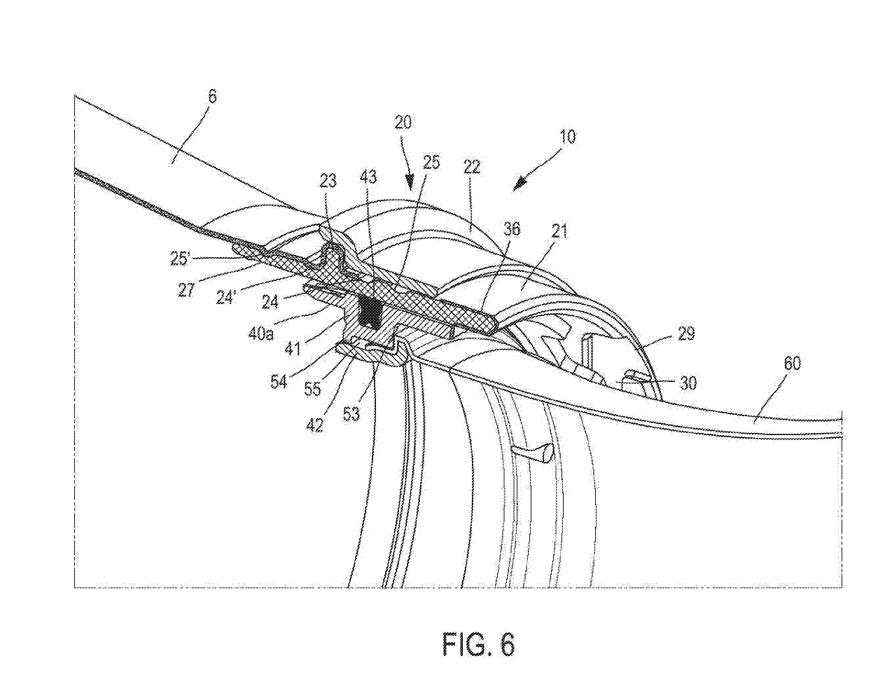

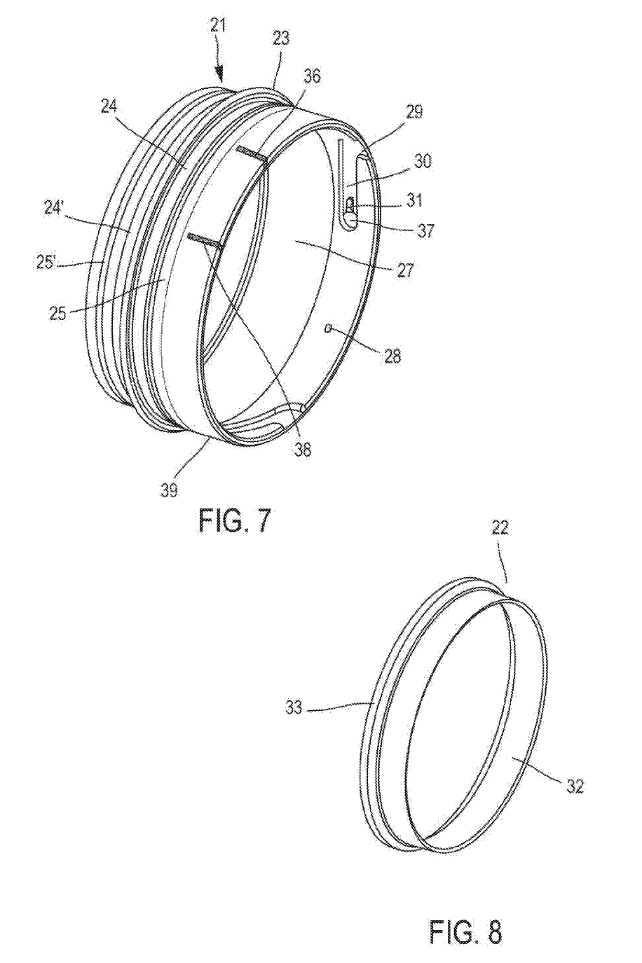

FIG. 6 at an enlarged scale enables details of the wrist ring 10a to be viewed with the cuff sleeve 20a and the glove sleeve 40a, the volume between both these sleeves enabling a proper gas penetration for fully sterilise this space. It ensures a proper decontamination of the uncovered surfaces. Depending on the operations to be performed for example in the animal field, the protection of this volume is self-evident to avoid any introduction detrimental to the system interchangeability. FIG. 6 enables the following figures to be better apprehended.
FIG. 7 represents the cuff sleeve body 21 alone.

The inside includes a clearing bore 28 in which at least three inlets 29 of helical ramps 30 preferably offset by 120° are located. These does not open to outside the cuff sleeve body 21. This clearing bore 28 is slightly greater than the bore 27 in order to avoid damaging the seal upon passing at the helical ramps 30 and enables the glove sleeve 40 a to be more readily introduced by the operator.

At the end of these helical ramps is an anti-unsealing spur 31 of a rectangular shape in the circular direction followed by a cavity 37 terminating the helical ramps 30, making possible to clip clip-on contacts 49 accommodated in the cavities 37. The function of the anti-return spur 31 is to prevent it from being unsealed upon passing in the groove 58. The functions of the cavity 37 are to hold in the latched position the glove sleeve body 41a/41b on the cuff sleeve body 21 and to generate the resonance of a “click” at the operator, confirming latching. Further, visual marks are located, the one 36 on the cuff sleeve body 21, the other 51 located on the glove sleeve body 41a/41b, it confirms this position by their alignment. The anti-return spurs 31 thus act as anti-return stopping any axial and radial movement between the cuff sleeve 20a/20b and the glove sleeve 40a/40b.

An engagement mark 38 enables the operator to bring visually the glove sleeve 40a/40b on the cuff sleeve 21, facilitating its engagement in the clearing bore 28. The bore 27 receives the seal 43 and ensures a continuous dynamic sealing throughout the interchangeability phase and then a static sealing.

The outside of the cuff sleeve body 21 comprises a first shoulder, on which the marks 36 and 38 are found, and which includes after these marks, a throat 25 enabling the glue deposit or the flow of material to be received in the case of a welding assembly. This is followed by a second throat called a sleeve end 24 avoiding a complex mounting of the cuff 6 to its cuff body 21. This housing is followed by a shoulder called a cusp 23 for holding the cuff. Finally, behind this cusp 23 on its outside of the ferrule 26, is found the symmetry of the throats 24 and 25 with a cuff end throat 24′ and with a throat 25′ enabling the system to be used in the case of a depressurised glove box.

FIG. 8 represents alone the collar for assembling the cuff sleeve 22 to the cuff sleeve body 21, the centring inside bore 32 ensuring the centring on the cuff sleeve body 21. The shoulder 33 comes against the cusp 23 enabling the cuff to be held by pressure as the gluing or welding sets. Further, this shoulder 33 has a very important second function, that of protecting the cuff 6 against shocks resulting in an increased lifetime.

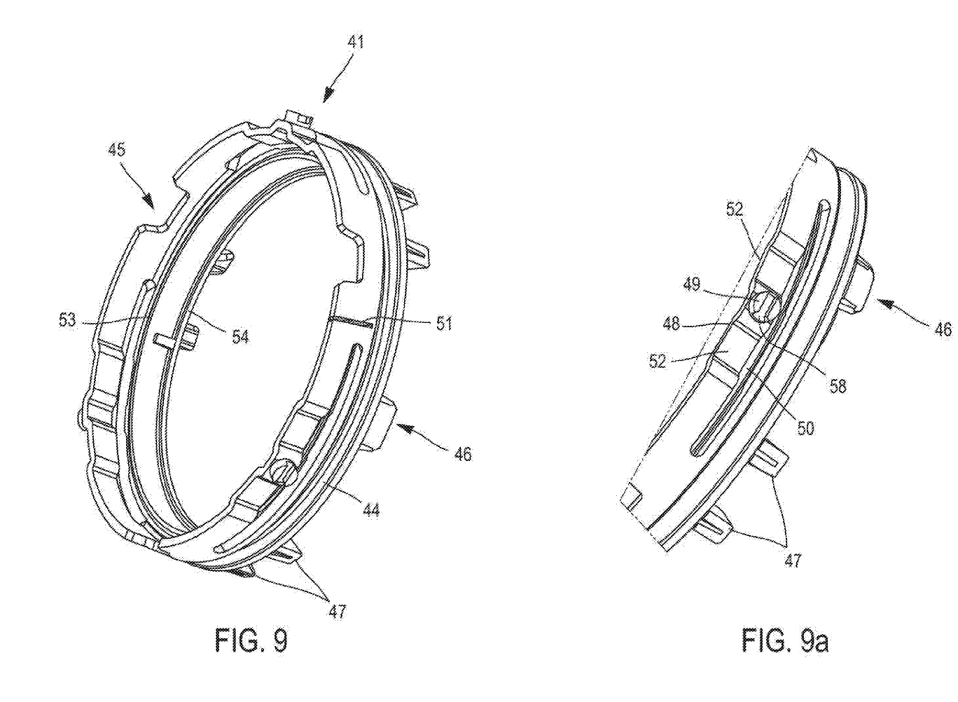

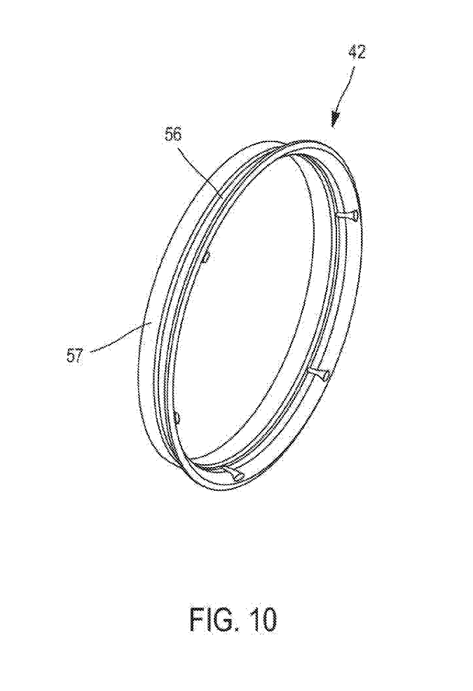

FIG. 9 represents alone the glove sleeve body 41. This ferrule shaped piece ensures the following functions:
unclipping by the three contact cancelling tenons 47 located behind the glove sleeve body 41, when engaged in the three housing pairs 52;
rotatable driving by three driving male slots 46 also located behind the glove sleeve body 41 and the three driving female slots 45 located at the front of the glove sleeve body 41 enabling the male slots 46 of the new glove sleeve 41 to be received;
clipping by three clip-on contacts 49 located on the three flexible sectors 48 at the front of the glove sleeve body 41;
reception of the contact cancelling tenons of the new sleeve of the new glove by the three housings 52, the gradual penetration of which during the placement of this new sleeve of a new glove by the operator results in that the tenons 47 radially cancel inside the glove sleeve body the clip-on contacts by virtue of the deformation of the flexible sectors 48. This flexibility is made possible by the three through ports 50;
sealing between outside the glove sleeve 41 and inside the cuff sleeve body 21. For this, a throat 44 makes it possible to receive the lobe type seal 43 in the example represented, but it can be lipped etc. This seal 43 should be made of a food material, rubber etc. (see FIG. 6). The sealing is ensured by the compression of the lobes of the seal 43 against the smooth inner wall of the bore 27 of the cuff sleeve body 21. The elastomer slipperiness is achieved by a surface ionisation which has the advantage to harden the elastomer of the surface and to increase the slipperiness by decreasing the friction coefficient. The ionisation can be made with auto-bactericide silver ions, which enables the part of the seal 43 in contact with inside the cuff sleeve body 21 to be kept sterile;
visual display of the glove sleeve 40 on the cuff sleeve, by virtue of a mark 51 on outside the cylindrical part of the sleeve body 41 and on the front slice;
sealing of the glove mounted on its assembling collar 42 (see FIG. 10) bearing against the inner shoulder 53 of the glove sleeve body 41;
undissociable holding of the glove by epoxide resin type gluing or the like, depositing or injecting glue is provided in a space 55 formed by the inner cusp 54 of the glove sleeve body 41 and the centring ferrule 57 of the glove assembling collar 42.

FIG. 9a, for a better understanding, represents a magnified detail of a flexible sector 48 with its clip-on contact 49, its housing 52 for receiving the cancelling tenons 47, and the groove 58 and the port 50.

FIG. 10 shows alone the glove assembling collar 42 made up of a flange 56 receiving the glove 60 and enabling it to be borne against the inner shoulder 53 of the glove sleeve body 41. This flange is terminated by a centring ferrule 57 with the guide inner cusp 54 of the glove sleeve body 41, see FIGS. 6 and 9.

Nomenclature

| Mark | Designation | |
|---|---|---|
| 2 | Wall (of the containment envelope) | |
| 4 | Shoulder ring | |
| 5 | Collar (for holding the cuff on the shoulder ring) | |
| 6 | Cuff | |
| 7 | Inside the cuff | |
| 10 | Wrist ring: | 10a pressurised mounting |
| | | 10b depressurised mounting |

| | | |
|---|---|---|
| 20 | Cuff sleeve: | 20a pressurised mounting |
| | | 20b depressurised mounting |

| | | |
|---|---|---|
| 21 | Cuff sleeve body: | 21a pressurised mounting |
| | | 21b depressurised mounting |

| | | |
|---|---|---|
| 22 | Collar for assembling the cuff sleeve: | 22a pressurised mounting |
| | | 22b depressurised mounting |

| 23 | Cusp (outside holding the cuff) | |
|---|---|---|
| 24 | Cuff end throat: pressurised mounting | |
| 24′ | Cuff end throat: depressurised mounting | |
| 25 | Throat (for glue for assembling 22 to 21): pressurised mounting | |
| 25′ | Throat (for glue for assembling 22 to 21): depressurised mounting | |
| 26 | Interchangeability ferrule | |
| 27 | Bore (of the ferrule ensuring a continuous sealing upon changing glove) | |
| 28 | Clearing bore (for protecting the seal) | |
| 29 | Inlet (for engaging the contacts in the helical ramps) | |
| 30 | Helical ramps | |
| 31 | Anti-return spur | |
| 32 | Inner bore (for centring 22 to 21) | |
| 33 | Shoulder (for holding 6 on 23 by axial pressure and protecting the cuff 6 | |
| | against shock) | |
| 36 | Visual mark (of end of latching) | |
| 37 | Cavity (for contacts after clipping) | |
| 38 | Mark of engaging the glove sleeve | |
| 40a, 40b | Glove sleeve: | 40a for pressurised mounting |
| | | 40b for depressurised mounting |

| | | |
|---|---|---|
| 41 | Glove sleeve body: | 41a for pressurised mounting |
| | | 41b for depressurised mounting |

| | | |
|---|---|---|
| 42a, 42b | (Glove) assembling collar: | 42a for pressurised mounting |
| | | 42b for depressurised mounting |

| 43 | Seal | |
|---|---|---|
| 44 | Throat (for the seal) | |
| 45 | Driving female slots (circular) | |
| 46 | Driving male slots (circular) | |
| 47 | Contact cancelling Tenon | |
| 48 | Flexible sectors supporting the clip-on contacts | |
| 49 | Clip-on contacts | |
| 50 | Through port (affording flexibility for the flexible sectors) | |
| 51 | Mark (visual for the alignment with the mark 36) | |
| 52 | Housing (for the cancelling tenons) | |
| 53 | Inner shoulder (for pressing against the glove skin) | |
| 54 | Inner cusp for guiding and forming a natural throat 55 between the sleeve | |
| | body 41 and the glove assembling collar 42 | |
| 55 | Space | |
| 56 | Glove bearing flange | |
| 57 | Ferrule (for centring on the glove sleeve body 41) | |
| 58 | Groove | |
| 60a, 60b | Glove: | 60a for pressurised mounting |
| | | 60b for depressurised mounting |

1. A bidirectional device for changing a handling glove from inside to outside a glove box and from outside to inside under containment, said device being intended to replace a used glove with a new glove, the bidirectional glove comprising:
a cuff sealingly connected to a shoulder ring sealingly mounted to a wall of a containment envelope sealingly connected to a cuff sleeve; and
a glove of a flexible material sealingly connected to a glove sleeve,
wherein the glove sleeve includes externally a predetermined number of clip-on contacts located on flexible sectors and the cuff sleeve, an inner surface of which is unobstructedly cylindrical, and
wherein the glove sleeve further comprises internally a same number of bayonet type helical ramps for guiding the clip-on contacts in the anchor cavities which are constructed to latch the glove sleeve into the cuff sleeve, and which form, once assembled, a sealed whole called a wrist ring.

2. The device for changing a glove according to claim 1, wherein a static and dynamic sealing, during interchangeability, comprises at least a seal injected or sealingly embedded in a throat of the glove sleeve provided on a body of the glove sleeve, to ensure a permanent sealing between the cuff sleeve and the glove sleeve.

3. The device for changing a glove according to claim 2, wherein the seal 444 is an elastomer and has undergone a surface ionisation enabling its slipperiness properties to be improved to facilitate placement of a new collar and ejection of an old collar.

4. The device for changing a glove according to claim 1, wherein the clip-on contacts and contact cancelling tenons are provided with a visual and mechanical foolproofing system, such that the glove is always put into a right working position.

5. The device for changing a glove according to claim 1, wherein, in order not to require a specific tool to perform the interchangeability handling by an operator, visual marks are used for facilitating displaying during interchangeability actions performed by a translation followed by a rotation of about 40°.

6. The device for changing a glove according to claim 1, further comprising a latching system which includes the clip-on contacts introduced in suitable cavities said clip-on contacts being able to be unclipped, using cancelling tenons, which are introduced into housings of the flexible sectors to be cancelled to inside the glove sleeve, to result in unclipping these clip-on contacts.

7. The device for changing a glove according to claim 1,
wherein the glove sleeve comprises a body of the glove sleeve including devices for guiding and latching said glove sleeve body into the cuff sleeve body, and a glove assembling collar of the glove in the body of the glove sleeve, and
wherein holding is ensured by gluing the glove assembling collar in the body of the glove sleeve.

8. The device for changing a glove according to claim 1, wherein the cuff sleeve comprises the cuff sleeve body and a cuff assembling collar adapted to press the cuff against a cusp of the cuff sleeve body, to provide sealing of the cuff sleeve, the whole being held by a resin type glue making them undissociable.

9. A method for replacing a used glove with a new glove, the method comprising:
displaying visual marks during interchangeability actions performed by a translation followed by a rotation of about 40°;
bringing a new glove sleeve onto a used glove sleeve in place in a cuff sleeve body, while aligning the mark of the new sleeve with the mark of the cuff sleeve body;
pushing the new glove sleeve onto the old glove sleeve; and
rotating, as a single piece, the new glove sleeve and the old glove sleeve by about 40° in the cuff sleeve body, until a mark of the new glove sleeve is aligned with a latching end mark located on the cuff sleeve body, as indicated by a “click” sound.

10. The method according to claim 9, further comprising:
providing a pressurised glove box, wherein the method begins with the following two phases:
rolling up the used glove to outside the cuff; and
rolling up the new glove equipped with its glove sleeve is inside a containment envelope.

11. The method according to claim 9, further comprising:
providing a pressurised glove box,
wherein, at an end of the method, the used glove sleeve is cleared off inside the cuff.

12. The method according to claim 9, further comprising:
providing a depressurised glove box, wherein the method begins with the following three phases:
rolling up the cuff to outside the cell;
rolling up the new glove to inside its sleeve; and
placing the new glove equipped with its glove sleeve outside a containment envelope.

13. The method according to claim 9, further comprising:
providing a depressurised glove box,
wherein, at an end of the method, the used glove sleeve is cleared off inside the glove box.
